(19) United States
(12) Patent Application Publication
(10) Pub. No.: US 2007/0140155 A1
(43) Pub. Date: Jun. 21, 2007

(54) METHOD FOR IMPLEMENTING MULTICAST BASED ON SWITCHOVER BETWEEN ACTIVE BOARD AND STANDBY BOARD IN ACCESS DEVICE

(75) Inventor: Jinning Yu, Shenzhen (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Huawei Technologies Co., Ltd., Shenzhen (CN)

(21) Appl. No.: 11/608,761

(22) Filed: Dec. 8, 2006

Related U.S. Application Data
(63) Continuation of application No. PCT/CN06/02146, filed on Aug. 23, 2006.

(30) Foreign Application Priority Data
Sep. 6, 2005 (CN) 200510099376.3

(51) Int. Cl. H04H 1/00

(52) U.S. Cl. 370/312; 370/390

(57) ABSTRACT

This present invention discloses a type of active and standby board backup and switchover method for access devices, comprising: maintain real time communications between standby board and active board, and check the operating status of the active board at all times; refresh standby board data based on changes to multicast client dynamic data in the active board; perform switchover from the active board to the standby board based on the active board failure detected; the new active board sends a multicast join request to the upstream router based on its saved data. Multicast client dynamic data comprises: multicast client online record, multicast client CDR (Call Detail Record), etc. Adopting the method of this invention guarantees that clients remain online during switchover, ensures an uninterrupted video stream, and thereby ensures that the switchover from active to standby does not significantly affect multicast services for multicast clients. Moreover, clients' multicast service CDR will not be lost, which protects the interests of the provider.

### CROSS-REFERENCES TO RELATED APPLICATIONS

The present application is a continuation of PCT Application No. PCT/CN2006/002146, filed Aug. 23, 2006, which claims priority to Chinese Patent Application No. 200510099376.3, filed Sep. 6, 2005. All of these applications are commonly assigned and incorporated by reference herein for all purposes.

### BACKGROUND OF THE INVENTION

The present invention relates to communication technology and in particular, it relates to a method for ensuring IP multicast service quality in access devices.

As networking technology and the Internet has developed, a huge variety of high-bandwidth multimedia applications have appeared, such as video conferencing, e-learning, telemedicine, Internet broadcasting, and so on. However, conventional networks were designed for classical point-to-point communication in order to guarantee reliable data transmission, and the vast majority of transport protocols used are also point-to-point. In this type of conventional network, high-bandwidth multimedia applications necessarily result in network congestion, increased latency and network bottlenecks. People have proposed many different solutions to relieve these bottlenecks, such as increasing bandwidth, changing network traffic structure, and applying IP multicast technology. Because IP multicast can effectively save network bandwidth and decrease network load, this technology has been widely applied.

To improve the reliability of communication devices, a scheme using active and standby devices with hot switchover is often applied. Active and standby hot switchover refers to two identical boards operating simultaneously, one board is active and one board functions as a standby. Currently, many access devices that support multicast video services support active and standby hot switchover. Consequently, when the active board breaks down, the system automatically switches over to the standby board.

In the majority of current access devices, the control board and network board are all in one, so when active board to standby board switchover occurs it cuts off transmission of the multicast video stream. Because client online and offline behavior is dynamic and unpredictable, the method used in the current technology is that client online data is not processed. Consequently, after switchover all online clients become offline. If a client wishes to watch a program, they must actively reorder the program in the same way as it originally came online.

The aim of switchover is to reduce failure time of a single board and its effect on service to an absolute minimum. However, if switchover causes all multicast clients to go offline, it affects all clients on every port of this access device, which is inconsistent with the motive and aim of switchover. Besides, because failure of a single board is unpredictable, if the standby board does not backup the CDR (Call Detail Record), when an active board fails, the new active board, following switchover, will lose the multicast service CDR. The provider uses the CDR to calculate client's video reception charge; this clearly causes the provider to suffer a significant loss.

Hence, how to keep clients online during the switchover process, ensure an uninterrupted multicast video stream, and lessen the impact on multicast service is an issue we must consider during switchover.

### BRIEF SUMMARY OF THE INVENTION

This invention provides a method that ensures the quality of IP multicast service, keeps clients online during switchover of access devices, ensures an uninterrupted multicast stream, and decreases the impact of switchover on the multicast service.

According to this invention, it provides a Standby Board Switchover Based Method of Implementing Multicast in Access Devices, said method includes:

Maintain real time communications between standby board and active board, and check the operating status of the active board at all times;

Refresh standby board data based on changes to multicast client dynamic data in the active board;

Perform switchover from the active board to the standby board based on the active board failure detected; and

The new active board sends a multicast join request to the upstream router based on its saved data.

The technical scheme described below is an optional technical scheme:

Once the switchover from active to standby is complete, the following steps are performed:

Once the backup data check is complete, the following steps are performed;

The new active board sends an online status query request to multicast clients;

The online status query request comprises: an IGMP (Internet Group Management Protocol) query message and MLD (Multicast Listener Discovery) protocol query messages.

The multicast client dynamic data comprises one or more of the following: multicast client online record, channel currently being watched by the multicast client, channel number, channel status, multicast client offline record, multicast client CDR (Call Detail Record).

Changes to multicast client dynamic data in the active board that refreshes standby board data comprise: refresh the multicast client online record, channel currently being watched, channel number and channel status on the standby board based on the online record, channel currently being watched by the multicast client, channel number, and channel status of the multicast client on the active board; and refresh the standby board's multicast client CDR according to said multicast client's online/offline record, and set or delete items in the hardware forwarding table of the standby board.

The access device described comprises a Digital Subscriber Line Access Multiplexer (DSLAM).

The multicast join request described comprises IGMP report messages and MLD protocol report messages.

This invention also provides an access device where said access device is installed with an active board and standby board. The standby board and active board maintain real time communication and checks the status of the active board at all times, and performs a switchover from the active board to the standby board based on errors detected on the active board, wherein said access device is also installed with a Backup Module and a Multicast Stream Request Module.

Backup Module: used to change data on the standby board based on changes to multicast client dynamic data in the active board;

Multicast Stream Request Module: once switchover is finished, it is used to send multicast stream request messages to the upstream router according to the data stored in the new active board following switchover, causing the upstream router to send the multicast data stream to the new active board after switchover.

The technical scheme described below is an optional technical scheme:.

The access device described is also installed with a Checking Module; Checking Module: after switchover from the active board to the backup board, it is used to check the accuracy and/or integrity of the data backed up by the Backup Module.

The access device described is also installed with a Status Request Module.

Status Request Module: used to send online status query request messages to multicast clients once the Checking Module completes its checks and causes the post-switchover new active board to obtain multicast clients' current status.

Adopting the technical scheme of this invention guarantees that clients remain online during switchover, ensures an uninterrupted video stream, and thereby ensures that the switchover from active to standby does not significantly affect clients. Moreover, clients' multicast service CDR will not be lost which protects the interests of the provider.

### BRIEF DESCRIPTION OF THE DRAWINGS

FIG. 1 shows an implementation example of a multicast video network for the present invention, in which the access device supports system switchover.

FIG. 2 is a procedural flowchart showing the system backup process between active and standby board.

FIG. 3 is a procedural flowchart for showing the system switchover process between active and standby board.

### DETAILED DESCRIPTION OF THE INVENTION

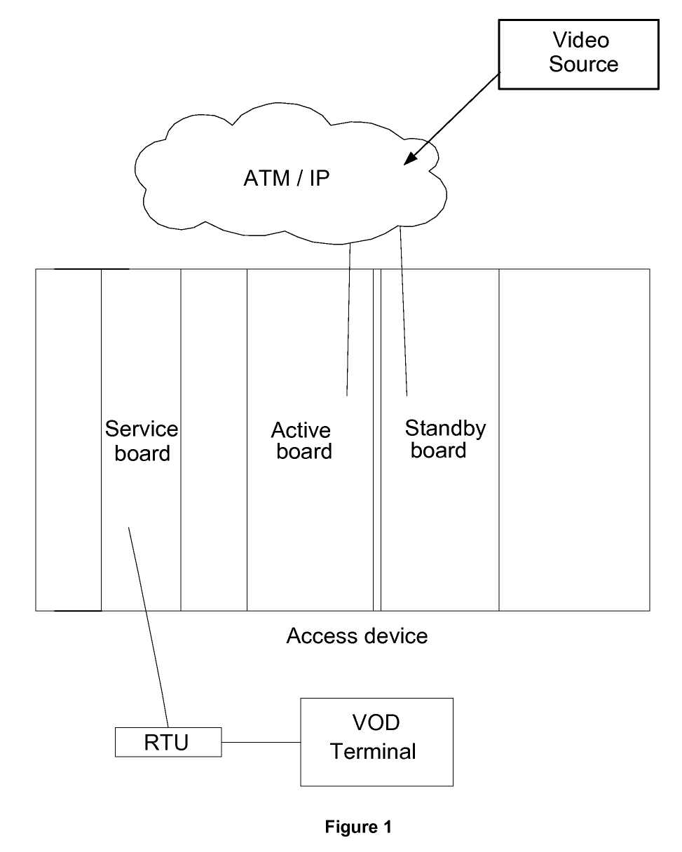

FIG. 1 illustrates a simple example of an IP multicast video network for the present invention, in which the access device supports system switchover. In the diagram shown, the network is comprised of a video source, ATM/IP network, access device, remote terminal unit (RTU), and Video-on-Demand (VOD) terminal. Among these, the access device comprises a main board (active board and standby board) and service board; the uplink port of the main board connects to a remote video source via an IP/ATM network, and an edge router (not shown in this figure) that supports multiple multicast protocols (for example, including IGMP (Internet Group Management Protocol) and MLD (Multicast Listener Discovery) protocols) connects to the access device. The service board (such as an xDSL (digital subscriber line) board) connects to the VOD terminal (such as a TV with STB, PC, laptop, Personal Data Assistant (PDA), multimedia mobile phone, etc.) via an RTU (Remote Terminal Unit) (such as an ADSL (Asymmetric Digital Subscriber Line) modem). According to different types of service boards and VOD terminals, there are many ways to connect an access device to remote clients, such as, via PSTN (using optical fiber, twisted pair or other transmission medium), WIMAX (World Interoperability for Microwave Access) and other methods of network access (such as wireless broadband access). The access device described in the above network structure can be a digital subscriber line access multiplexer (DSLAM) or any other access device.

During IP multicast services, when a multicast client comes online, a multicast join message is sent, such as an IGMP report message. The service board then forwards the message to the main board, and the main board then sends the multicast join message to an upstream router. Requests for video streams are sent from routers to the video server using a multicast routing protocol (e.g. PIM-SM (Protocol Independent Multicast—Sparse Mode), PIM-DM (Protocol Independent Multicast-Dense Mode), or MSDP (Multicast Source Discovery Protocol). The video stream then follows the transmission circuit taken by the previous message to the uplink port of the main board; then the main board and service board forward them to the client making the request based on a forwarding table. When the currently operating main board breaks down, the access device automatically switches over to the standby board.

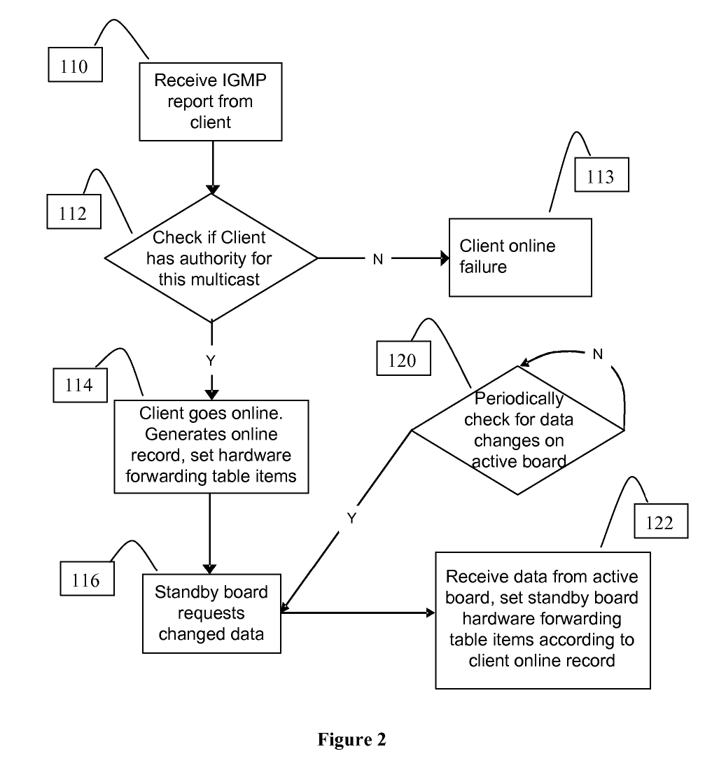

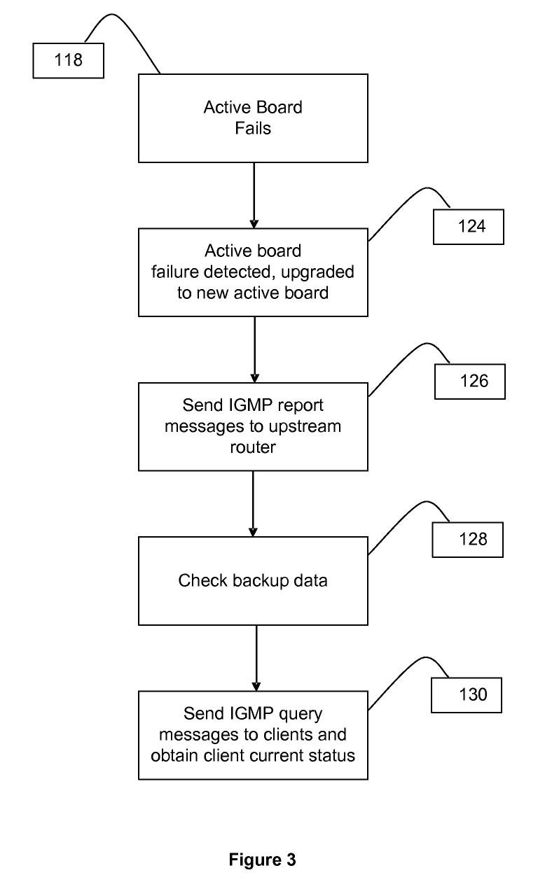

To ensure that the multicast clients remain online during system switchover, the video stream is not cut off and the multicast client CDR is not lost, thereby the impact on multicast service is minimized as much as possible. This invention provides flowcharts showing the system backup and switchover processes between the active board and standby board, as shown in FIGS. 2 and 3.

FIG. 2 below describes in detail the hot data backup implementation process for this invention. In FIG. 2, the active board is a master control board currently in a working state; the standby board is a master control board currently in a backup state.

The hot data backup process shown in FIG. 2 comprises the execution steps for the active board and the standby board.

When a multicast client connects to the network via the VOD terminal of an RTU, the VOD terminal creates a multicast join message from the client's VOD request and sends this to the access device; said method then starts to execute step 110.

In step 110, the access device receives a multicast client join message and passes it to the main board for processing.

Then step 112 is executed; the main control board checks whether the client's multicast request has authority to watch the program and determines the next step according to the check result. If the client does not have authority, go to step 113: the client fails to go online and this method concludes. If the client has authority, then execute step 114.

In step 114, the access device processes the multicast client and brings it online, generates an online record for the multicast client, sets items in the hardware forwarding table for the multicast stream, and forwards the video stream from the uplink port of the active board to the client port. In this way, the multicast client can receive the video stream.

During logon, the standby board executes step 120. In as much as the system maintains real time communication between the active board and standby board, the standby board periodically checks whether data on the active board has changed. When a multicast client goes online and the active board generates a client online record, the standby board detects a data change on the active board (comprising client online record, channel the client is currently watching, channel number, channel status, and timer status) and then sends a backup request to the active board.

Next, the active board executes step 116. The active board sends the requested data to the standby board thus ensuring consistency of data between the active board and standby board.

Next, in step 122, the standby board receives the data sent by the active board and sets the hardware forwarding table in the standby board according to the client's online record. Because the uplink port of the standby board is inactive, it does not forward a video stream, thus the hardware forwarding table in the standby board does not interfere with or affect stream forwarding in the active board.

When a multicast client goes offline (not shown in FIG. 2), it generates a corresponding CDR in the active board. Meanwhile, the online record for the multicast client changes and corresponding items in the hardware forwarding table are deleted. At this point the standby board detects changes to the multicast client online record, multicast client offline record and multicast client CDR on the active board, and sends a backup request to the active board. The active board then sends the requested data to the standby board and the standby board also deletes corresponding items in its hardware forwarding table according to the multicast client offline record and other data. At this point, the multicast client CDR is already backed up on the standby board.

The above process ensures that multicast client online and offline dynamic data, call detail records and item settings in the hardware forwarding table on the standby board are identical to those on the active board.

The following describes the system switchover process in detail with reference to FIG. 3.

The active board in FIG. 3 is a master control board currently in a working state; the standby board is a master control board currently in a backup state. When a failure in the active board occurs, the system switches from a hot data backup phase to the switchover phase,

In step 118, the active board fails and executes step 124; the standby board detects the abnormal status of active board, immediately implements switchover from the active board to the standby board and the standby board becomes the active board.

Thereupon, step 126 is executed; the new active board (i.e. the former standby board) sends multicast join request messages to the upstream router according to the multicast client online records, in order to avoid aging of forwarding table in the upstream router and to ensure an uninterrupted multicast stream. Because the forwarding table in the new active board (i.e. the former standby board) is already set, multicast streams can be transferred to multicast clients quickly. The period of stream interruption during switchover is merely the time it takes to restore communication links between the new active board (i.e. the former standby board) and service boards. The time it takes is in microseconds.

Afterwards, step 128 is executed, the new active board checks backup data; for example, it checks the logical relationship among backup data to ensure data accuracy and integrity.

Following this, step 130 is executed; the new active board sends multicast query messages to multicast clients to obtain their current status. During switchover, the new active board is unable to process protocol messages for a short period of time because it is busy checking each item of data backed up from the old active board, Therefore, during this checking period, the new active board is unable to perform normal processing of multicast query messages and multicast quit messages. To prevent aging of multicast clients and the inability of multicast clients to go offline, after completing data checks, it must immediately send IGMP query messages to the multicast client in order to ensure the access device obtains the current status of multicast clients as quickly as possible.

FIG. 2 illustrates the process of data backup and switchover between active board and standby board. In this figure, the hot data backup only shows the hot data backup process for multicast clients during the process of coming online. The principle of hot data backup for multicast clients during the process of going offline is consistent with the online process.

Adopting the method of active and standby data backup and switchover in this invention maintains data consistency in the active and standby boards while operating, and when the active board fails, the standby board becomes the new active board. The new active board sends IGMP report messages to upstream routers requesting the required video stream, and immediately transfers streams to multicast clients using the same hardware forwarding table items as the original active board. Accordingly, it keeps multicast clients online, maintains an uninterrupted video stream, and ensures the multicast client CDR is not lost during the switchover process from active to standby. In addition, after completing checks on backup data, the new active board sends IGMP query messages to multicast clients to obtain their current status, thus enabling immediate processing of client requirements. In summary, a method of the present invention can reduce the impact of active board failure on multicast services and improves multicast service quality.

The access device in this invention has an active board and a standby board. The standby board maintains real time communication with the active board, and checks the working status of the active board. Switchover from the active board to the standby board is implemented according to the active board failure detected. The access device presented in this invention is also installed with a backup module, a checking module, a status request module and a multicast stream request module. The backup module, checking module, status request module, and multicast stream request module can be installed in the standby board, and of course, can also be installed independently to the standby board.

The backup module is used to change data on the standby board based on changes to multicast client dynamic data in the active board. Here, the multicast client dynamic data comprises: multicast client online record, channel currently being watched by the multicast client, channel number, channel status, timer status, multicast client offline record, multicast client CDR (Call Detail Record), etc. The backup module can refresh the standby board's multicast client CDR according to changes in the multicast client's dynamic data, set or delete items in the hardware forwarding table of the standby board, etc. The detailed method is as described above.

The checking module is used to check the accuracy and/or integrity of the data backed up by the Backup Module, after switchover from the active board to the backup board has been performed.

During the checking procedure, the backup board does not process multicast join and multicast leave messages sent by multicast clients during this process normally. Hence, to prevent aging of multicast client online status and the inability to go offline, after checking is completed, the request status module in this invention sends query messages to multicast clients. In this way, the post switchover new active board can correctly obtain the multicast client's current status.

The multicast stream request module is primarily used once switchover is finished to send multicast stream request messages to the upstream router according to the multicast client online record, channel currently being watched by the multicast client, channel number, channel status, and other data. In this way, the upstream router can send the requested multicast data stream to the new active board based on the multicast stream requests it receives. The new active board following switchover provides the multicast client with a multicast service with an uninterrupted multicast stream according to the multicast client online record, channel currently being watched by the multicast client, channel number, channel status, and other data. In addition, because the new active board following switchover contains a backup of the multicast user CDR, the access device main board switchover process does not cause loss of the multicast user CDR information.

In the above description of the access device, the specific representation of online status query request messages, multicast data stream request messages and access devices are as described in the above method.

1. A method for implementing multicast in an access device based on switchover between an active board and a standby board, characterized by comprising:
maintaining a real-time communication between a standby board and an active board, and checking an operating status of the active board at all times;
changing data in the standby board based on a change to multicast client dynamic data in the active board;
performing a switchover from the active board to the standby board based on a detected failure for the active board; and
the new active board sending a multicast data stream request message to an upstream router based on saved data.

2. The method according to claim 1, wherein after the switchover from the active to the standby is completed, also performing the following step:
the new active board checking accuracy and/or integrity of backup data.

3. The method according to claim 2, wherein after the checking the backup data is completed, also performing the following step:
the new active board sending an online status query request to a multicast client.

4. The method according to claim 3, wherein the online status query request comprises: an Internet Group Management Protocol (IGMP) query message and an Multicast Listener Discovery (MLD) protocol query message.

5. The method according to claim 1, wherein the multicast client dynamic data comprise one or more of the following: a multicast client online record, a channel currently being watched by a multicast client, a channel number, a channel status, a multicast client offline record, a multicast client Call Detail Record (CDR).

6. The method according to claim 5, wherein the changing data in the standby board based on a change to multicast client dynamic data in the active board includes: refreshing data on the standby board for multicast client online record, channel currently being watched by a multicast client, channel number and channel status based on a change in the online record, the channel currently being watched by the multicast client, the channel number, and the channel status on the active board; and refreshing a multicast client CDR for the standby board according to said multicast client online/offline record, and setting or deleting items in a hardware forwarding table of the standby board.

7. The method according to claim 1, wherein said access device comprises a Digital Subscriber Line Access Multiplexer (DSLAM).

8. The method according to claim 1, wherein the multicast data stream request message comprises an IGMP report message and an MLD protocol report message.

9. An access device where said access device includes with an active board and a standby board, the standby board and the active board maintaining a real time communication and checking an operating status of the active board at all times, performing a switchover from the active board to the standby board based on a detected failure for the active board, wherein said access device also includes a backup module and a multicast stream request module;
the backup module: used to change data in the standby board based on a change to multicast client dynamic data in the active board;
the multicast stream request module: after the switchover from the active to the backup is completed, used to send a multicast data stream request message to an upstream router based on data stored on the new active board, causing the upstream router to send a multicast data stream to the new active board after the switchover.

10. The device according to claim 9, wherein said access device also includes a checking module;
the checking module: used to check accuracy and/or integrity of the backup data in the backup module, after the switchover from the active board to the backup board is completed.

11. The device according to claim 10, wherein said access device also includes a status request module;
the status request module: used to send an online status query request message to a multicast client after the checking module completes its checking, causing the new active board to obtain a multicast client current status after the switchover.
